(19) United States
(12) Patent Application Publication
(10) Pub. No.: US 2026/0309532 A1
(43) Pub. Date: Oct. 8, 2026

(54) CONTAINERS TO ALLOW DUPLICATION OF SECRET CHEF RECIPES

(71) Applicant: Vilma Leal, Lakewood, CO (US)

(72) Inventor: Vilma Leal, Lakewood, CO (US)

(21) Appl. No.: 19/169,833

(22) Filed: Apr. 3, 2025

(51) Int. Cl. G01F 19/00; B33Y 80/00; B65D 21/02

(52) U.S. Cl. CPC G01F 19/00; B65D 21/0233; B33Y 80/00

(57) ABSTRACT

A plurality of containers are provided to allow a Chef to keep the amount, by volume or weight, of an ingredient in a recipe secret. The plurality of containers include a cavity to receive the ingredient and indicia on the container of the ingredient or a corresponding indicating indicia. Optionally, the indicia may include the recipe name. The amount, volume or weight, of the ingredient is unmark on any of the containers. In other words, there is no indicia of weight or volume on the containers.

### CROSS-REFERENCE TO RELATED PATENT APPLICATIONS

None.

### BACKGROUND

Being a Chef is highly competitive. The culinary industry is fast-paced and demanding, with Chefs constantly striving to differentiate themselves through creativity, skill, and innovation. In popular food scenes, particularly in major cities, there is an intense race for recognition and success, with Chefs competing for everything from prime restaurant locations to positive reviews from critics and food enthusiasts. Success as a Chef often requires not only talent but also resilience and the ability to adapt to changing trends and consumer preferences.

The profit margins for running a restaurant are extremely tight. Chefs often face pressure not only to create exceptional food but also to manage the business side of their operations efficiently. Chefs must balance recipe creativity with practicality to ensure their ventures are profitable. This constant balancing act, combined with the need to stand out in a crowded market, makes being a Chef a challenging and highly competitive career.

As can be appreciated from the above, Chefs strive for unique recipes to differentiate themselves and attract customers. However, as any particular recipe become popular, there will be an increase demand for multiple parties to be able to repeat the recipe to satisfy the demand. Sharing recipes, however, is undesirable as it may promote theft of the recipe.

To combat theft of their recipes, Chefs often keep their recipes secret to protect their unique culinary creations and maintain a competitive edge in the food industry. One of the primary ways they do this is by only sharing certain parts of a recipe with their kitchen staff, ensuring that no single person knows the entire process. This compartmentalization can include keeping specific ingredient measurements or techniques confidential. However, as demand for a recipe increases, the ability to maintain confidentiality becomes difficult.

Against this background, it would be desirable to provide apparatuses and methods to allow duplication of a recipe by others in a kitchen or restaurant without disclosing the specifics of the recipe.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

The technology provided herein provides a plurality of containers, a method of producing a plurality of containers, and a non-transitory storage media containing instructions to print a plurality of containers. Th plurality of containers allow a Chef to keep the amount, by volume or weight, of an ingredient in a recipe secret. The plurality of containers include a cavity to receive the ingredient and indicia on the container of the ingredient or a corresponding indicating indicia. Optionally, the indicia may include the recipe name. The amount, volume or weight, of the ingredient is unmark on any of the containers. In other words, there is no indicia of weight or volume on the containers.

These and other aspects of the present system and method will be apparent after consideration of the Detailed Description and Figures herein.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 depicts a plurality of containers nested consistent with the technology of the present application.

FIG. 2 depicts the plurality of containers of FIG. 1.

FIG. 3 depicts the plurality of containers of FIG. 1 unnested consistent with the technology of the present application.

FIG. 4 depicts the plurality of containers of FIG. 3.

FIG. 5 depicts another plurality of containers consistent with the technology of the present application.

FIG. 6 depicts another plurality of containers consistent with the technology of the present application.

FIG. 7 depicts another plurality of containers consistent with the technology of the present application.

FIG. 8 the plurality of containers of FIG. 5.

FIG. 9 depicts a specially programmed additive manufacturing processor consistent with the technology of the present application.

FIG. 10 an additive manufacturing device consistent with the technology of the present application.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense. Moreover, the technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As described above, in the ultra-competitive landscape of owning a restaurant and food services, a Chef can derive value by recipes and the implementation of recipes to deliver a distinctive product, taste, experience, or the like (generically “experience”). However, as the popularity of the experience increases, the ability of a singular Chef to prepare the ingredients and/or the one or more recipes, the more the Chef requires assistance in the preparation and the like if not the actual cooking or baking. When the Chef shares a recipe with an individual that individual (such as an assistant Chef, sous Chef, etc.) becomes privy to a portion of the ingredients, recipe, or preparation instructions. The more popular the experience, the more of the ingredients, recipe, and/or preparation is shared to keep up with demand. The individual may ultimately become a competitor.

The conventional Chef typically tries to protect some portion of the ingredients, ingredient sourcing, recipe, preparation, and may limit the information to portions that are common or not secret. For example, a Chef may give the assistant Chef the ingredient source information and the ingredients and the Chef may give the recipe to the sous Chef, but withhold the preparation information. Of course, this is but one example of a way to limit the information regarding the Chef's secret experience. As can be appreciated, it becomes more and more difficult to maintain secrets as the Chef/restaurant becomes more and more popular.

The technology of the present application provides systems, methods, and apparatuses to allow a Chef to provide tools to an assistant or sous Chef such that they can replicate the experience but not identify the specifics of the experience. While described with specific to certain ingredient mixes for recipes, the technology described herein may be used in other applications, such as, for example, chemical composition mixtures and the like.

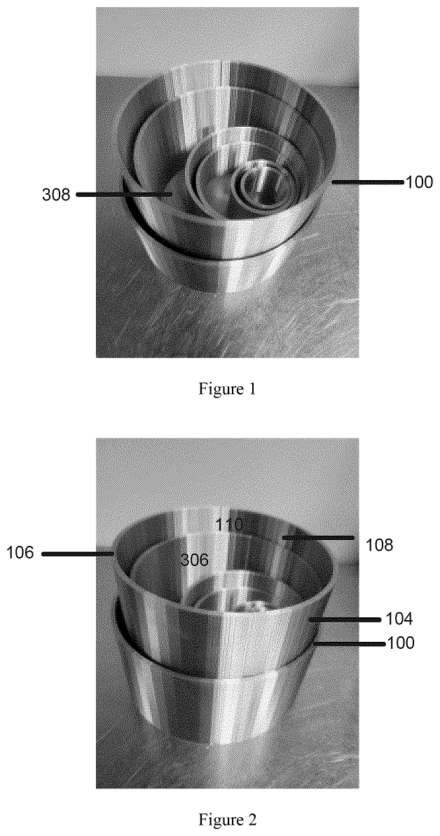

The technology of the present application is shown in an embodiment in FIGS. 1 and 2. FIG. 1 shows a plurality of volumetric containers 100 from a first perspective view. The volumetric containers 100 may be constructed using an additive manufacturing process, an example of which is described below. FIG. 2 shows the plurality of volumetric containers 100 from a second perspective view. The plurality of volumetric containers 100, as described below, are shown nested, or stacked. Allowing the containers to nest, as shown, facilitates storage and the like but the containers do not need to nest and each ingredient may have a differently shaped container. Also, the volumetric containers 100 are shown as cylindrical containers although other nesting shapes are possible, such as, for example, cubic shapes, triangular shapes, octagonal shapes, random shapes and the like. Also, alternative or random shapes are possible and may facilitate the ability of the plurality of volumetric containers 100 in maintaining the recipe difficult to determine from the size of the container.

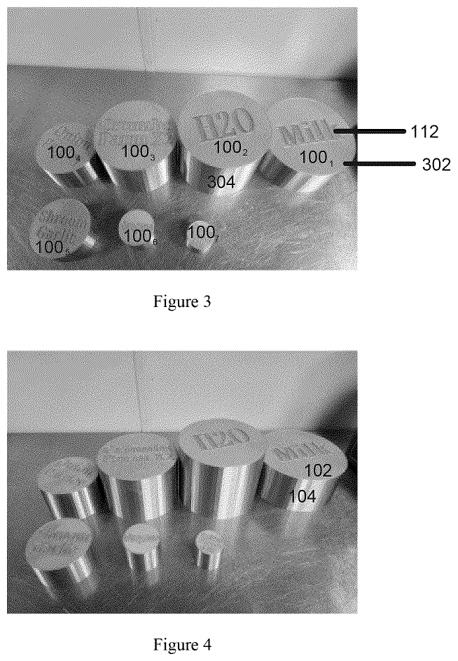

FIGS. 3 and 4 show the plurality of volumetric containers 100 unnested and upside down for explanatory purposes. The plurality of volumetric containers 100 may be for a recipe to make a certain amount of bread or the like, although in the examples the specifics of the end product is not overly relevant. As shown, the plurality of volumetric containers 100 include seven (7) distinct containers 100₁₋₇. Each of the containers 100₁₋₇ has a bottom 102 and a sidewall 104 extending from the bottom 102 towards an upper surface 106 of the sidewall 104 that defines an opening 108 to a cavity 110 having a predefined, but unmarked, volumetric size. In other words, unlike conventional measurement devices, the containers 100 do not have any indicia of weight or volume associated with the size of the cavity. In other words, it is notable that the volumetric containers contain a defined amount of volume in the cavity 110, but that the actual amount of volume (ounces, quarts, liters, grams, etc.) are not marked on the container such that the container does not identify the amount of an ingredient. So, for example, container 100₁ provides for a quantity of an ingredient, specifically milk, to be added to a recipe associated with the plurality of containers 100, but does not identify the amount, volume, or quantity of the ingredient.

FIGS. 1-4 show a plurality of containers 100 where each container 100₁₋₇ is associated with one (1) ingredient. In certain embodiments, there may be additional containers to allow for combinations of ingredients. For example, a recipe may have multiple containers for ingredients and additional containers for combining certain of the ingredients in advance of preparing the recipe. For example, a recipe may have a container A for flour, a container B for baking soda, and a container C where the ingredients from container A and container B are combined. In this manner, the recipe may be further hidden as the assistant preparing the ingredients for the recipe provides container C (and any other containers with ingredients) to the assistant actually making the recipe but not container A and B such that the assistant making the recipe does not know the contents of container C and, even if they did, they would have even less information about the amount of either ingredient.

Each container 100₁₋₇ is shown with an opening 108 such that cavity 110 is uncovered, in certain embodiments the opening 108 may be provided with a cap or plug (not specifically shown). The cap or plug may be fitted to the opening such that friction holds the cap or plug in place. Alternatively, the cap or plug may be hinged to the sidewall 104 or the upper surface 106. This allows the cavity to be covered when not in use to protect the inside from contamination or the like. In still other embodiments, the cap or plug may include a pour spout or funnel to facilitate pouring the related ingredient (or chemical) into or out of the cavity 110.

The cavities 110 of the present technology, in certain embodiments, are sized to not equate with a typical measuring unit for a recipe, such as, for example, cups, quarts, pint, a liter, ounces, grams, etc. Because the sizing is not specifically for a typical recipe measurement, the recipe, for example, remains secret although others know the ingredients for the recipes. Also, it is possible to police theft of the recipe as a person would need to determine the volume of each containers' cavity 110, which typically would involve measurements of the sizing that would be viewable by others in the kitchen, laboratory, or the like.

As shown in FIGS. 3 and 4, the plurality of containers 100 each have indicia 112. The indicia 112 provides the ingredient, chemical, or the like, associated with the container for the particular recipe. Container 100₁ in FIG. 3 has indicia 112 on the outer bottom surface 302 where the indicia 112 is milk. As identified above, however container 100₁ provides an indication of milk, but does not provide the amount, volume, or quantity of milk to be added to the recipe. Similarly, container 100₆ has indicia on the outer bottom surface 302 where the indicia 112 is oregano. Rather than words, the indicia 112 may be colors, numbers, or other indicators. If the actual ingredient is not listed, the indicia may be considered a corresponding ingredient indicating indicia. If the indicia is the corresponding ingredient indicating indicia, i.e., something other than the actual ingredient, such as a number, the instructions for preparing the recipe would include a step indicative of, for example, fill container 1 with milk. Also, while shown on the outer bottom surface 302, the indicia 112 may be provided on the outer sidewall surface 304. In still other embodiments, the indicia 112 may be provided on the inner sidewall surface 306 or inner bottom surface 308. The indicia 112 may be etched into the surface or added using an additive manufacturing operation. In yet other embodiments, the indicia 112 may be added via a sticker adhered to the container.

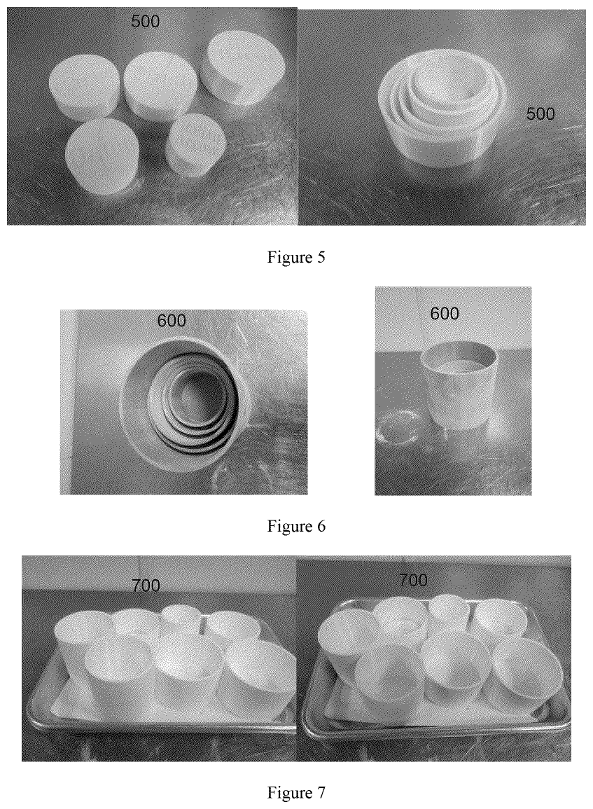

FIGS. 5, 6, and 7 show additional containers. The plurality of containers 500 would be associated with a second recipe, typically different from the recipe (the first recipe) of the plurality of containers 100. The plurality of containers 600 would be associated with a third recipe, different from the first and second recipes. The plurality of containers 700 would be associated with a fourth recipe, different from the first, second, and third recipes. Notice, first, second, third, and fourth are simply to designate different recipes and should not be considered limiting. Thus, in this particular example, the kitchen staff could prepare the 1^{st} through 4^{th} secret recipes without knowledge of the amount, quantity, or volume of any of the ingredients without the Chef being present and without the Chef disclosing the secret. While the present example shows four (4) different groups of containers, the technology is applicable whether the organization uses one, two, or as many groups of containers as secrets there are for the Chef. Also, the technology of the present application is applicable for recipes having at least two (2) ingredients to any number of ingredients. In certain embodiments, only a portion of the ingredients for a particular recipe have the containers associated with the present application. For example, a recipe may have 16 ingredients where three (3) ingredients have containers consistent with the technology described herein and the remaining 13 ingredients are added to the recipe using conventional measurement devices, such as, tablespoons, teaspoons, cups, liters, grams, ounces, or the like.

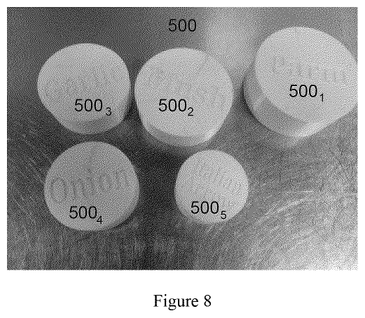

The method of using the technology is described herein as well. The method includes a series of steps, but each step may be separated into multiple additional steps. Moreover, listed steps may be combined. Finally, additional steps not specifically identified may be added to the technology described herein. With reference to FIG. 8, an exemplary methodology is described. The plurality of containers 500 are provided in FIG. 5 and referenced as containers 500₁, 500₂, 500₃, 500₄, and 500₅. The plurality of containers are initially provided empty. The containers 500 are filled with the appropriate ingredients, which in this case are: 500₁ parmesan cheese, 500₂ mushrooms, 500₃ garlic, 500₄ onion, and 500₅ Italian arrow. However, the specific ingredient as exemplary. In certain cases, the ingredients are liquids, such as water and milk. Liquids are added to the container until the liquid reaches a fill line or the upper surface 106, such as is shown in FIG. 1. Other ingredients may be compacted, such as, for example, brown sugar. In these cases, the recipe may call for different types of packing. In one type of packing, the brown sugar may be loosely poured into the container to the fill line or upper surface 106. In another type of packing, the brown sugar may be poured and compacted by the user repeatedly until the container has a packed fill. In yet another example, the brown sugar may be added until overflowing slightly and patted to provide the container with a baker's fill or the like. In each case, the user may use a flat edge or knife blade to level the ingredient at the upper surface 106 so the correct amount of the ingredient is prepared. Finally, once the ingredients are into the containers, the ingredient is added to the recipe at the appropriate place. Notice the ingredients may be in the containers before starting the recipe or as the required ingredient is called for in the recipe, which is helpful if the recipe calls for adding the same amount of the same ingredient at different times, such as, for example, add a container of water to the mixture and one minute later add another container of water to the mixture, or the like.

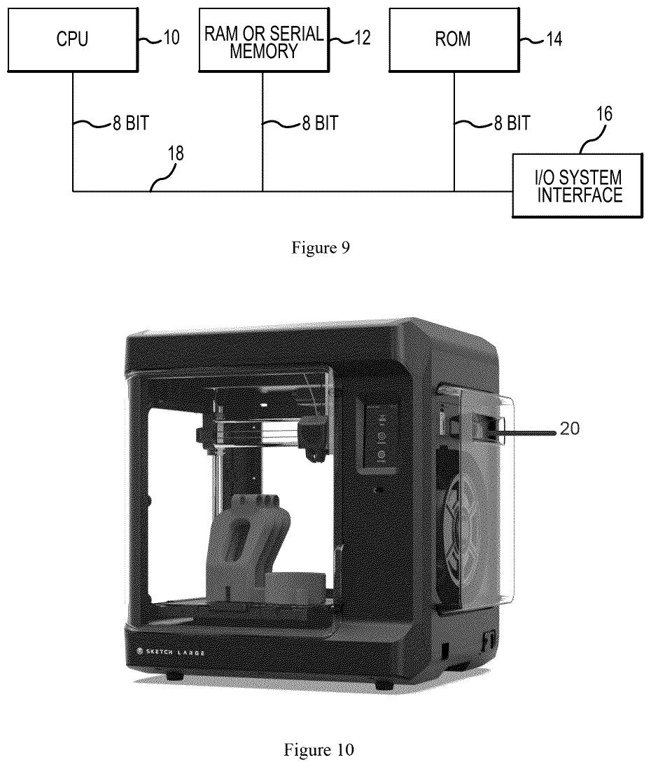

FIG. 9 shows an exemplary specially programmed additive manufacturing processor 1. The specially programmed additive manufacturing processor 1 compresses a processing unit 10, random access memory (RAM) 12, or some other serial memory, read only memory (ROM) 14, and a basic input/output system (BIOS) 16. The parts of the specially programmed additive manufacturing processor 1 are coupled via a bus or the like as shown (although shown as a generic bus, other bus protocols, network protocols, or wireless protocols are possible). The processing unit 10 and BIOS 16 in this exemplary embodiment may provide a user interface that can allow a user to input data to the specially programmed additive manufacturing processor 1. The user interface, not specifically shown, may be integrated with the specially programmed additive manufacturing processor 1 or remotely accessed via a network, such as a private or public network like the Internet. The specially programmed additive manufacturing processor 1 contains programs and data, some of which is input by a user, in the RAM 12 and/or ROM 14 to allow the processor 10 to carryout the functionality explained below. The processing unit 10 and BIOS 16 in this exemplary provides additive manufacturing instructions, such as in a program file, to an additive manufacturing device 20 shown in FIG. 10, such for example, a 3d printer. The additive manufacturing device 20 may be integrated with the specially programmed additive manufacturing processor 1 or remotely accessed via the network

The specially programmed additive manufacturing processor 1 may operate in the following exemplary matter. First, the processing unit may provide a display of a graphical user interface, step A. The graphical user interface may, in certain embodiments, request a title or name for the receipt, step B, such as, for example, Vilma's Gelato. The user (chef or recipe owner) next may be prompted by the graphical user interface to input an ingredient Nᵢ, step C, and an amount of the ingredient Nᵢ, step D. The amount of the ingredient may be either a mass, weight, volume, or the like. The processing unit 10 may next prompt the user to indicate whether there is a next ingredient Nᵢ₊₁, step E. If there is the next ingredient, the processing unit returns to step C, D, and E for the Nᵢ₊₁ ingredient and amount. Once at least one of the ingredients and the associated ingredient amount is input, the processing unit builds a container print file for the ingredient and amount, step F. The container print file is next sent from the processing unit 10 to the 3d Pringer 20, step G, which prints the container, step H. The container print file may contain instructions such that the indicia of the ingredient is printed on the container for the ingredient. The print instructions, consistent with the technology described herein, however, would not include the ingredient amount on the container. The container print file also may print the title or name of the recipe on container as part of printing indicia. For example, the container may be printed with the ingredient, eggs, and the name of the recipe, such as, Vilma's Gelato. Finally, and optionally, the print file may be saved for future replication under the name Vilma's Gelato or the like for the chef (or recipe owner). In certain embodiments, the print file may be deleted after the container is printed for security.

The technology described herein optionally comprises many networked machines. The figures depict a diagrammatic representation of a machine, in the example form, of a computer system within which a set of instructions, for causing the machine to perform any one or more of the methodologies discussed herein, may be executed.

The computer system includes a processor, memory, non-volatile memory, and an interface device. Various common components (e.g., cache memory) are omitted for illustrative simplicity. The computer system is intended to illustrate a hardware device on which any of the functions, applications, engines, and scripts are running as described herein and shown in figures (and any other components described in this specification) can be implemented. The computer system can be of any applicable known or convenient type. The components of the computer system can be coupled together via a bus or through some other known or convenient device.

The processor may be, for example, a conventional microprocessor such as an Intel microprocessor, Motorola microprocessor, or the like. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software s typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium”. A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted reside in the interface.

In operation, the computer system 1100 can be controlled by operating system software that includes a file management system, such as a disk operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Although the technology has been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. An apparatus to facilitate maintaining a recipe secret comprising:
a plurality of containers, wherein,
each container of the plurality of containers is associated with at least one ingredient of a recipe;
each container of the plurality of containers has a bottom and at least one sidewall;
each container of the plurality of containers has an indicia on the container associated with one ingredient of the recipe and no indicia indicative of the amount of the ingredient; and
each container of the plurality of containers has a cavity defined in part by the bottom and the at least one sidewall to receive the one ingredient.

2. The apparatus of claim 1, wherein at least one of the plurality of containers is manufactured using an additive manufacturing process.

3. The apparatus of claim 1, wherein the indicia includes the name of the recipe.

4. The apparatus of claim 1, wherein the plurality of containers nest.

5. The apparatus of claim 1, wherein the plurality of containers stack.

6. The apparatus of claim 1, wherein the plurality of containers are cylindrical.

7. The apparatus of claim 1, wherein at least one of the plurality of containers has fill line.

8. The apparatus of claim 1, wherein the plurality of containers container openable tops.

9. The apparatus of claim 1, wherein the indicia is adhered to the container.

10. A method of making containers to facilitate making a recipe using ingredients of a known amount without disclosing the amount of the ingredient comprising:
displaying, by a processing unit, a user interface configured to receive from a recipe owner;
receiving, by the processing unit, data input at the user interface wherein the data received includes a plurality of ingredients and an ingredient amount for each ingredient of the plurality of ingredients;
generating, by the processing unit, a container print file for each of the plurality of ingredients where the container print file creates an ingredient container having a defined cavity to receive the container that corresponds to the ingredient amount, but does not indicate the ingredient amount;
transmitting, by the processing unit, the container print file to an additive manufacturing apparatus that is configured to print the containers from each container print file such that the container includes indicia of the ingredient but not the ingredient amount.

11. The method claim 10, wherein the indicia includes the name of the recipe.

12. The method of claim 11, wherein the container print file contains instructions to print cylindrical containers.

13. The method of claim 12, wherein the cylindrical containers are nestable.

14. The method of claim 10, wherein the container print file prints stackable containers.

15. The method of claim 10, wherein the container print file contains instructions for a 3d printer.

16. A non-transitory computer-readable storage medium comprising a set of instructions that,
when executed by one or more processors, cause a machine to:
display a user interface to a recipe owner, where the user interface is configured to receive data including a plurality of ingredients and an ingredient amount for each of the plurality of ingredients;
receive the data input by the owner of the recipe at the displayed user interface;
generate a container print file for each of the plurality of ingredients associated with the data input by the owner of the recipe wherein the container print file is configured to cause an additive manufacturing device to build the container of the container print file with a cavity sized to receive the ingredient amount for the ingredient; and
transmit each container print file to an additive manufacturing device configured to manufacture the container print file.

17. The storage medium of claim 16, wherein the container print file is for a 3d printer.

18. The storage medium of claim 16, wherein the container print file contains instructions to print indicia of the ingredient on the container.

19. The storage medium of claim 18, wherein the user interface is further configured to receive data regarding a recipe name and the container print file contains instructions to print indicia of the recipe name on the container.

20. The storage medium of claim 16 wherein the generated container print files are configured to print nestable containers.
